(19) United States
(12) Patent Application Publication
(10) Pub. No.: US 2005/0223088 A1
(43) Pub. Date: Oct. 6, 2005

(54) System using planning information to modify operation of a digital network

(75) Inventor: Ori Gerstel, Los Altos, CA (US)

Correspondence Address: CARPENTER & KULAS, LLP, 1900 EMBARCADERO ROAD, SUITE 109, PALO ALTO, CA, 94303, US

(73) Assignee: Cisco Technology, Inc.

(21) Appl. No.: 10/815,889

(22) Filed: Mar. 31, 2004

(51) Int. Cl. G06G 7/70

(52) U.S. Cl. 709/223

(57) ABSTRACT

Planning stage information is used for network configuration and/or control at an operation stage. A list of recommended routes (LoRR) is generated by one or more planning tools. The LoRR includes a list of routes between different endpoints, the granularity of the route (i.e., allocable bandwidth amounts), description of the type of links used by the route and list of intervening nodes, if any. The LoRR is provided to a process executing at a time of operation of the network. In a preferred embodiment, the LoRR is used by a Network Operations Center (NOC) or other centralized network control system. In other embodiments, the use of the LoRR information can be distributed such as by using the LoRR information within a router, switch or other network processor or process (i.e., operation process).

### BACKGROUND OF THE INVENTION

This invention relates in general to digital networks and more specifically to the use of information obtained at a network planning stage to configure or modify the network during an operation stage.

Two distinct stages of deployment of a digital network are a planning stage and an operation stage. In the planning stage, human network designers use network planning tools that typically execute on a computer system. The planning tools can be used to simulate complex network systems so that the design of the simulated systems can be rapidly tested, optimized and made more robust for conditions such as changing user or provider needs, load balancing, equipment failure, topology changes, etc. A planning tool can help the network designers predict how a network will operate and can allow the designers to define preferred ways of handling future needs.

For example, types of future needs include changing traffic requirements or new bandwidth provisioning. A network designer can predefine or allocate recommended routes for future traffic based on network topology and hardware compatibilities and performance. Inevitably there are many options in how to route traffic. These options are only a few of the factors that go into a decision on how to optimize the network. For example, a route can be selected based on the physical distance of the route between two communicating devices. Or a route can be selected based on the number of “hops” or intermediary devices that a transmission will encounter, the relays, retransmissions, conversions or other connections and interfaces that a signal must traverse, etc. Factors such as signal conversion, retransmission or other compatibility and interfacing concerns can be critical in applications where optical networks are used, especially where the optical networks are mixed with electrical networks to form a hybrid network.

Once the network has been planned, it is usually deployed in adherence to the plan. However, once deployed, the network is placed under a control system that analyzes the network differently from the tools used in the planning stage. Typically, a control system at the operation stage must act instantly and automatically based on information obtained at or near the time of action.

For example, if there is an equipment failure or a new demand for bandwidth an operation stage control system may be instructed to operate on a rule to use the next best route. Such a “best” route may be determined as the shortest path route, or the one with the fewest number of hops between sender and receiver. Although this rule can successfully solve the immediate problem of assigning new bandwidth, it can fail to take into account overall, or longer term, characteristics of the network and can therefore fail to provide a more optimized network as time goes by.

The planning tools tend to use more sophisticated routing algorithms than operational control software. The planning tools also benefit from knowing upfront future traffic details that allow design of a more efficient overall network. Today's operational control systems often lack detailed optical engineering characteristics and are inadequate to handle reconfigurable optical networks. For example, operational controls may fail to determine when optical impairments necessitate regeneration of a signal along an optical path.

### SUMMARY OF EMBODIMENTS OF THE INVENTION

In one embodiment planning stage information is used for network configuration and/or control at an operation stage. A list of recommended routes (LoRR) is generated by one or more planning tools. The LoRR includes a list of routes between different endpoints, the granularity of the route (i.e., allocable bandwidth amounts), description of the type of links used by the route and list of intervening nodes, if any. The LoRR is provided to a process executing at a time of operation of the network. In a preferred embodiment, the LoRR is used by a Network Operations Center (NOC) or other centralized network control system. In other embodiments, the use of the LoRR information can be distributed such as by using the LoRR information within a router, switch or other network processor or process (i.e., operation process).

In one embodiment the invention provides a method for allocating a resource in a digital network, the method comprising using a network planning tool to define a recommended resource; determining when a resource is needed at a time of operation of the digital network; and allocating the resource according to the definition of the recommended resource at a time of operation of the digital network.

In another embodiment the invention provides a method for creating a list of recommended routes to be used by a network control system at a time of network operation, the method comprising generating a list of recommended routes based on predicted network topology; associating a service instance with a recommended route including one or more of the following: source node, destination node, service type, service granularity maximum delay, protection type, special equipment needs; and sending the list of recommended routes to a processor that is in communication with a network for use during operation of the network to select a routing of information based on the list of recommended routes.

In another embodiment the invention provides a method for allocating a new routing for information in a digital network at a time of operation of the digital network, the method comprising receiving a list of recommended routes, wherein the list of recommended routes includes information obtained at a planning stage of the digital network; and using the list of recommended routes to create a new route for information transfer in the digital network.

### BRIEF DESCRIPTION OF THE DRAWINGS

FIG. 1 illustrates a basic network suitable for use with the present invention;

FIG. 2 illustrates conceptual stages in a lifetime of a network;

FIG. 3A shows a new routing that would typically be selected at an operation stage;

FIG. 3B shows two routings that could be defined by a planning tool; and

FIG. 4 illustrates basic subsystems in a node device.

### DETAILED DESCRIPTION OF EMBODIMENTS OF THE INVENTION

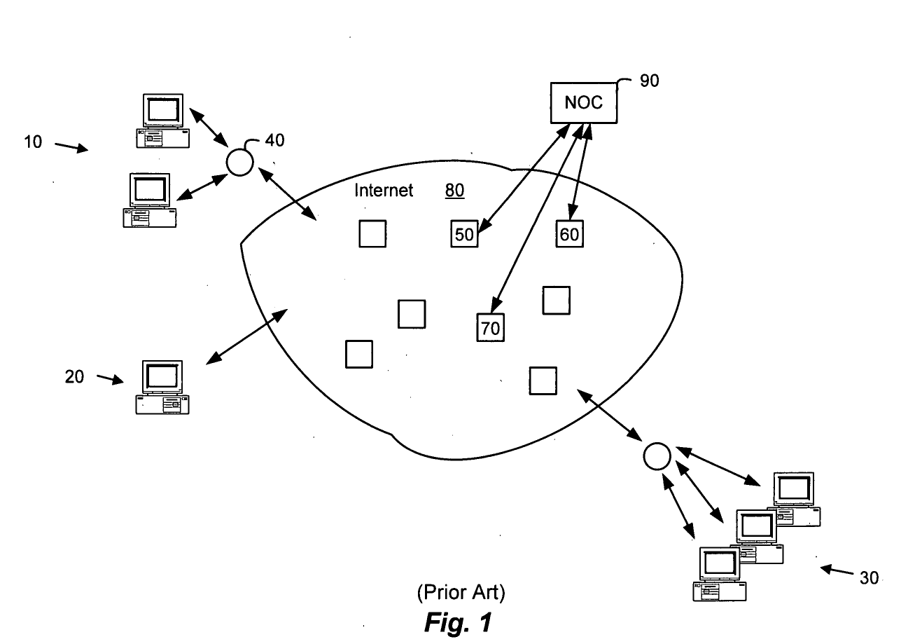

FIG. 1 illustrates a basic network, such as the Internet, a corporate or campus intranet, local area network (LAN), wide-area network (WAN), home or small network, etc. In FIG. 1, users at computers such as 10, 20 and 30 can initiate or receive transfer of information using network 80. Typically, there can be a local network device, processor, or other system (including another network) represented as node 40 to handle local processing, routing, switching, storage, interfacing or other network functions.

The network 80 includes various network devices, resources and other digital processing and related devices and processes as represented by nodes such as 50, 66 and 70. These devices and processes can include any type of network-related functionality such as a router, switch, bridge, server, storage system, etc. The nodes can include hardwired, wireless, optical or other types of communication and processing modes. As is known in the art, information can be exchanged among users (or devices) via nodes according to conventions and protocols such as Internet Protocol (IP), File Transfer Protocol (FTP), Hyper-Text Transfer Protocol (HTTP), etc. In general, any type of network having a suitable network design and topology, transmission protocols, devices and other functions or characteristics can be used to advantage with embodiments of the present invention.

A Network Operations Center (NOC) 90 is used to monitor, coordinate and maintain the operation of different network elements (e.g., nodes and resources). When a change is made to the network during the operation stage, the NOC is used to manage and control the implementation of the change. An automated process, or a human manager, working with tools, utilities, controls or other functionality provided by the NOC directs the modification to network operation. For example, if a new route is needed because of an equipment failure, the allocation of the route is performed by, or with, the NOC. Today's NOCs operate using various systems such as a Network Management System (NMS), Operations Support System (OSS), transport manager, etc. In general, any type of network analysis and control system or functionality can be provided by a NOC. Such systems can operate either automatically, manually, or as a combination of human operation with automated processes.

A NOC is typically operated by, or under the domain of, a company entity such as a network service provider who may own and operate various of the network nodes and resources. In a large network such as the Internet, there are many NOCs each dealing with a subset of the nodes and resources used by the Internet. Typically, the NOCs and their associated nodes and resources are organized at a business commercial level so that different service providers can compete for sale or license of their services and/or resources to purchasers or subscribers. Often, a NOC is concerned with providing services and support to a subscriber according to agreed-upon terms. Such terms can include provisions for increased bandwidth, guaranteed support, etc. Since a NOC can be tasked with balancing many such parameters for many different subscribers, the allocations of resources can become very complicated.

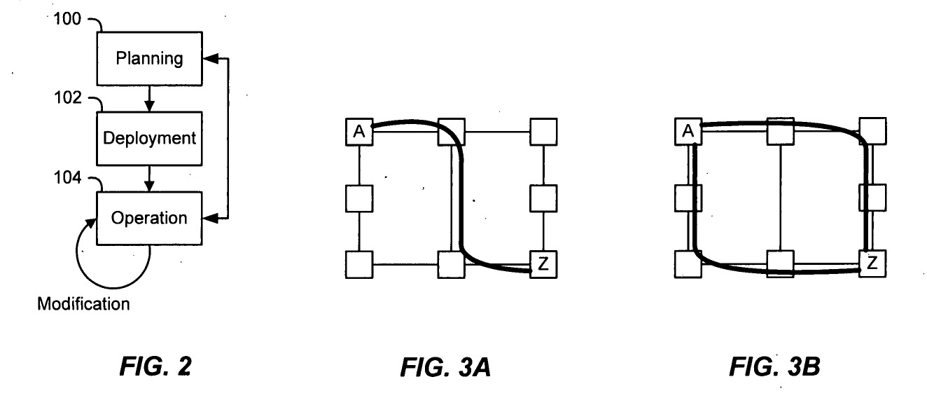

FIG. 2 illustrates conceptual stages in a lifetime of a network.

In FIG. 2, planning stage 100 includes using software planning tools to design a base system that provides targeted performance requested by a customer, such as a serviced provider. For example, one type of planning tool is MetroPlanner™ by Cisco Systems, Inc. It should be apparent that any suitable types of planning tools can be used. One typical function of a planning tool is to accept a definition of a network's design requirements and to select network equipment and equipment configurations to achieve the requirements.

In order to achieve its goals, the planning tool is provided with detailed information on all equipment characteristics. The planning tools use the detailed information along with complex routing analysis algorithms. These planning tool routing algorithms are typically more complex, comprehensive and accurate than tools used at an operational stage because the algorithms do not need to achieve a solution on short notice. Thus they can, for example, investigate more routing possibilities, analyze compatibility and performance factors; and perform deeper heuristic analysis than might be possible at a time of operation. The advantages of analysis at the planning stage are important in hybrid systems where optimization of optical and electrical signal transfer and transmission can be crucial to success of a network.

Once a network is planned, the equipment is purchased, configured and deployed at a deployment stage 102. The deployment stage is largely logistical and mechanical and includes integration and testing of equipment to achieve proper operation. In some embodiments, information obtained during the deployment stage can be provided back to tools in the planning stage in case the predicted models, relied-upon equipment characteristics, or other data upon which planning relied is different from the actual data obtained from the deployment stage. It is contemplated that future deployment techniques will include increasing automation and that planning information can be provided to the deployment stage in a similar manner as that discussed below in connection with the operation stage.

Once a network is deployed, operation stage 104 commences. During the operation stage, the equipment is placed into service and is managed and controlled by a devices and processes at a NOC, or other network control system. The NOC modifies network operation and allocation of resources as time goes by. For example, the NOC can allocate additional routes for traffic as the need arises or as customer subscriptions for new service are received. A preferred embodiment of the invention allows information from the planning stage to be provided to the operation stage in the form of a List of Recommended Routes (LoRR) that is described in detail, below. Other embodiments can provide for different types and degrees of planning information to be provided to devices and processes at the operation stage.

The LoRR (and other information) can be used for provisioning, failure recovery, analysis, optimization or other purposes. A preferred embodiment of the invention provides details on optical engineering aspects of a hybrid network. This allows processes at the operation stage to take advantage of sophisticated simulation results from planning tools to determine problems such as when an optical impairment requires regeneration of a signal along an optical path. Other advantages can be realized.

FIGS. 3A and 3B illustrate a possible routing advantage that can be achieved by a preferred embodiment of the invention.

FIG. 3A shows a new connection that would typically be selected at an operation stage by an operation tool using a “shortest path” routing. In FIG. 3A, it is desired to allocate a route from node A to node Z. Each box represents a node and a line represents a link between nodes so that the shortest number of intervening links (i.e., “hops”) is shown to be 3. This allocation might be selected by an operation process (e.g., a routing algorithm) executing at one or more of the nodes since the operation process may not have knowledge of the overall design and connectivity (i.e., topology) of the network, or network subsystem under the control of a NOC.

FIG. 3B shows two connections that could be defined by a planning tool. Note that the number of hops for each of the two connections in FIG. 3B is 4—more than the number of hops of the connection determined by the operation process in FIG. 3A. However, the longer hop routing of FIG. 3B allows two separate connections to be supported by the same network equipment (assuming each link can handle a single connection). Thus, with information provided from the planning stage, the operation processes can be instructed to allocate one of the two paths of FIG. 3B when a new connection route is desired. This allows the network to be configured for maximum volume rather than shortest path. A decision can be made by the NOC or by a node process to allocate according to volume or speed at the time that allocation is requested. Many such network optimization advantages and other advantages can be obtained. FIGS. 3A and 3B are but one type of simplified example.

In one embodiment, information from the operation stage can also be sent back to the planning stage for inclusion into subsequent analysis. The operation stage can also request a new, modified, or different approach to plan information from the tools in the planning stage. This may be desirable if conditions or assumptions change at the operation level after current planning information was generated. Planning tools can be used with any operation stage information sent to the planning stage tools and additional, or updated, results can be provided to the operation stage processes. Types of operation processes or systems that can use planning stage information include Network management System (NMS), Operations Support System (OSS), Element Management System (EMS), Craft Terminal (CT), distributed control planes such as Generalized Multi- Label Switching (GMPLS), Specific examples for such systems include Cisco Transport Manager (CTM) and Cisco Transport Controller (CTC).

A preferred embodiment of the invention includes planning information to enhance reconfigurable optical add-drop multiplexing (ROADM) in a multi-service transfer platform (MSTP). In general, any type of planning information may be of benefit to operation stage processes and/or a NOC or other network control system.

Table I, below illustrates information in an example format for a LoRR as generated by planning tools in a preferred embodiment.

TABLE I

| Entry | Endpoints | Type | Bandwidth | | Route |
|---|---|---|---|---|---|
| 1 | A→B | Ethernet | 500 | Mb/s | A-X-Y-B |
| 2 | A→B | FibreChannel | 1.2 | Gb/s | A-Z-B |
| 3 | A→B | Ethernet | 1.0 | Gb/s | A-X-Y-V-B |
| 4 | A→B | SONET | 2.488 | Gb/s | A-S-T-B |
| 5 | A→D | Ethernet | 1.0 | Gb/s | A-S-T-D |
| | . | | | | |
| | . | | | | |
| | . | | | | |
| n | Q→L | Ethernet | 500 | Mb/s | Q-M-N-L |

In Table I, each entry indicates a recommended route that can be allocated at the operation stage to establish communication between the two endpoints. The endpoint communication is limited to the indicated bandwidth and proceeds through the nodes listed in the Route heading. In a preferred embodiment, the LoRR is ordered so that allocation will preferably proceed in the order of entries (i.e., 1, then 2, then 3, etc.) assuming other criteria such as required bandwidth, number of hops, etc., are satisfied by the particular entry.

For example, during operation an operation process that needs to establish another route between nodes A and B will consult the LoRR. If the required bandwidth is not more than 500Mb/s the operation process will allocate, or use, the route described by Entry 1. In a preferred embodiment, if the next available entry for the desired endpoints does not satisfy current requirements (e.g., bandwidth, latency) the operation process will scan down the list until it identifies a satisfactory route and will then use that route. The operation process can be programmed to use the LoRR according to additional rules or information . For example, the operation process can combine two or more routes together to achieve desired bandwidth, or can perform other actions as described, below.

Other embodiments can use different formats for the LoRR. In general, any type of planning stage information can be included in a list that is exported to the operation stage and/or the deployment stage. For example, a route can be asymmetrical where different directions along the route provide different capacities. Details on interfaces, such as whether a node requires electrical, optical, wireless or other conversion, signal conditioning, etc., can be provided for use at the operation stage. Error rate, reliability (e.g., susceptibility to weather, lifetime, mean-time-between-failures, historical performance), statistical performance, shared traffic, and any other data about a route can be provided, including other relevant information about the network.

Note that the format of Table I is designed to provide a simple list so that analysis and processing at the operation stage is minimized. For example, the format of Table I assumes that the planning stage tools define possible routes by taking into account electrical and optical compatibilities and optimization. Thus, the operation stage processes that use the list do not have to perform such analysis and reach a conclusion about electrical and optical compatibility. However, other embodiments can provide basic details about the network to the operation processes which can then attempt to perform the analysis at operation time. The type and amount of detail that is provided in the LoRR is a design choice and the tradeoffs include faster allocation of routes at operation time by using simplified LoRR information with less operation processing, versus the ability to use real-time operation information with the LoRR recommendations and more operation processing to achieve more intelligent routing at the operation stage.

The LoRR is exported from the planning tools to the operation processes. Exporting can be done periodically by transferring the LoRR over a network to the NOC or another operation process. Periodic updates to the LoRR can be performed automatically. Updates can include planning tool analysis that has the benefit of operation information provided by the operation stage processes or devices. For example, if the network topology changes after deployment then the new topology can be provided to the planning tools for generation of an updated LoRR. Exporting or transfer of LoRR (or other) information from the planning stage can be by discrete media such as an optical or magnetic disc, memory device, etc. Any effective transfer means can facilitate exporting of planning stage information such as wired, wireless, optical or other mechanisms.

Although a preferred embodiment of the invention uses a list format to convey route information, any type of data format, structure, or design can be used. Multiple LoRRs can be provided and different operation processes can use different LoRRs. A centralized LoRR can be stored, for example, in the NOC to facilitate updating and distributed to multiple operation processes. In an embodiment where the NOC is controlling nodes in a subsystem, the NOC can use the LoRR information to control the operation processes and devices to allocate new routes.

Table II illustrates a LoRR operation stage information maintained by one or more operation processes. In a preferred embodiment, the operation process merely keeps track of which route has been allocated. In designs where multiple operation processes are designed to use LoRRs with some independence, the allocation of route entries in the distributed LoRRs must be coordinated.

TABLE II

| LoRR Entry | Status |
|---|---|
| 1 | free |
| 2 | allocated |
| 3 | allocated |
| 4 | free |
| . . . | . . . |
| n | free |

If a LoRR route has been allocated, the allocation is communicated to other operation processes that can be affected (i.e., processes within a same subnet). At such time as an allocated route is made available, the change in status is also propagated. Any approach as is known in the art for tracking and allocating resources to prevent conflicts can be used. For example, an approach similar to locked file sharing in operating systems can be employed.

Depending on a specific implementation or embodiment of the invention, various decisions can be made at the operation stage using the LoRR information. For example, one design approach may be to keep some LoRR routes in reserve. If a service provider is under an obligation to give guaranteed bandwidth to certain subscribers then such an approach may be useful where the overall traffic demands can fluctuate. The operation processes can monitor the efficiency of a given LoRR that is based on a “plan” used at the planning stage that, for example, is designed to allocate resources according to a first set of assumptions. If the LoRR is determined to not be efficient in actual network operation then a request can be generated by an operation process to re-generate the LoRR according to a new plan, or new set of assumptions. The efficiency of the LoRR can be measured by the number of times it does not contain an available entry of the required type out, divided by the number of requests (this metric is often called “hit ratio”).

A variation of this approach is to generate multiple alternative LoRRs in a set where each LoRR is created according to a different plan. The set of LoRRs can be exported and stored at the NOC or at a different operation process and a decision can be made during the operation stage to switch from a first LoRR that is not functioning as desired, to a second LoRR in order to see if the second LoRR provides better performance. A LoRR's performance can be monitored at the operation stage according to any number of factors including traffic volume, number of LoRR routes successfully used over time, etc.

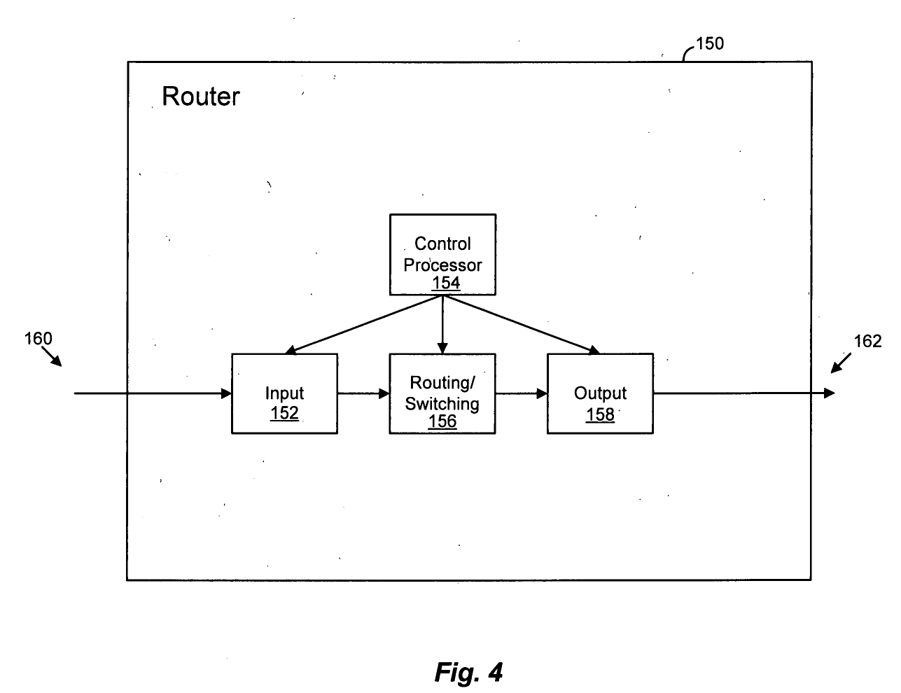

FIG. 4 illustrates basic subsystems in a node device, in this case a router, suitable for use with embodiments of the invention. In general, any type of network device, processor or other hardware and/or software can be suitable for providing functionality in association with the present invention. For example, functionality described herein as being performed by an “operation process” can performed in one or more of a NOC, Synchronous Optical Network (SONET) add/drop multiplexer or cross-connect, router, switch, server or client system, storage system or device, relay, provisioning system, etc.

In FIG. 4, router 150 includes control processor 154 for controlling other subsystems and components in the router such as input 152, routing/switching 154 and output 156. Control processor 154 can include any number and type of processing devices, data and instructions. Control processor 154 can include, memory, disk drives, or other types of storage; and can include communication or transmission means and other resources. Any type of suitable processing architecture can be used.

Packets or other data units to be routed or switched enter router 150 at input 152. The packets can have a header, payload or other information including sequence numbers. The router can store and route or switch the packets via router/switcher 154, using tables, indexes or any suitable approach. Such routing control can make use of the LoRR data as discussed above. Output 158 can condition the packets for transmission and can assign new sequence numbers according to the present invention. Any of the steps or functions described herein can be performed at one or more of the subsystems shown in FIG. 4. For example, the selection of a route from the LoRR, implementation of routing information into tables and other data structures, configuration of hardware, etc. can use control processor 154. Communication with other operation processes (including devices) can be by output 158 or by another subsystem (not shown) in router 150.

Although the invention has been discussed with respect to specific embodiments thereof, these embodiments are merely illustrative, and not restrictive, of the invention. For example, a “network planning tool” can include any type of analysis, manual or automatic, to anticipate the needs of a network at a time of network operation. A network control system or management service can be any type of control used at a time of operation to reconfigure or modify a network or to otherwise allocate network resources. A network resource can implicate any type of network performance characteristic such as bandwidth (e.g., physical or virtual links or channels; time division, code division, frequency division or other multiplexing or sharing of lines, etc.), signal conversion and/or interfacing, processing resources (e.g., CPU cycles, memory capacity, storage, input/output ports or other resources, etc.), network storage, buffering or other network resources.

Although specific protocols have been used to describe embodiments, other embodiments can use other transmission protocols or standards. Use of the terms “peer,” “client” and “server” can include any type of device, operation or other process. The present invention can operate between any two processes or entities including users, devices, functional systems or combinations of hardware and software. Peer-to-peer networks and any other networks or systems where the roles of client and server are switched, change dynamically, or are not even present are within the scope of the invention.

Any suitable programming language can be used to implement the routines of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific-details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

1. A method for allocating a resource in a digital network, the method comprising
using a network planning tool prior to a time of operation of the digital network to define a recommended change in use of the resource;
determining when a resource is needed at the time of operation of the digital network; and
allocating the resource at the time of operation of the digital network according to the definition of the recommended change in use of the resource.

2. The method of claim 1, wherein the change in use includes a recommended route.

3. The method of claim 2, wherein a plurality of recommended routes is defined.

4. The method of claim 3, further comprising
defining a priority order of the plurality of recommended routes; and
allocating the plurality of recommended routes at least in part according to the priority order.

5. The method of claim 1, wherein the resource includes a service instance having one or more of the following: source node, destination node, service type, service granularity, maximum delay, protection type.

6. The method of claim 1, wherein the resource includes routing information.

7. The method of claim 6, wherein the routing information includes equipment needs.

8. The method of claim 7, wherein the routing information indicates whether a route uses a switching matrix.

9. The method of claim 1, further comprising
sending the definition of a recommended resource to a network management system.

10. The method of claim 1, further comprising
sending the definition of a recommended resource to an Element Management System.

11. The method of claim 1, further comprising
sending the definition of a recommended resource to a Craft Terminal.

12. The method of claim 1, further comprising
sending the definition of a recommended resource to a control plane.

13. The method of claim 1, wherein the resource includes a description of a characteristic of an optical network.

14. The method of claim 1, further comprising
receiving information generated at a time of deployment of the digital network; and
using the received information to modify the definition of a recommended resource.

15. The method of claim 1, further comprising
receiving information generated at a time of operation of the digital network; and
using the received information to modify the definition of a recommended resource.

16. A method for creating a list of recommended routes to be used by a network control system at a time of operation of a digital network, the method comprising
generating a list of recommended routes at a time prior to network operation, based on predicted network topology;
associating a service instance with a recommended route including one or more of the following: source node, destination node, service type, service granularity maximum delay, protection type, special equipment needs; and
sending the list of recommended routes to a processor that is in communication with a network for use during operation of the network to select a routing of information based on the list of recommended routes.

17. The method of claim 16, further comprising
ordering the list so that a priority of use of the recommended routes is indicated by the ordering.

18. The method of claim 16, further comprising
receiving information obtained at a time of deployment of the digital network;
modifying the list in response to the received information; and
sending the modified list to the processor.

19. The method of claim 16, further comprising
receiving information obtained at a time of operation of the digital network;
modifying the list in response to the received information; and
sending the modified list to the processor.

20. A method for allocating a new routing for information in a digital network at a time of operation of the digital network, the method comprising
receiving a list of recommended routes, wherein the list of recommended routes includes information obtained at a planning stage of the digital network;
using the list of recommended routes to allocate a new route for information transfer in the digital network at a time of operation of the digital network.

21. An apparatus for allocating a resource in a digital network, the apparatus comprising
a processor;
a machine-readable medium including instructions executable by the processor comprising
one or more instructions for using a network planning tool prior to a time of operation of the digital network to define a recommended change in use of the resource;
one or more instructions for determining when a resource is needed at the time of operation of the digital network; and
one or more instructions for allocating the resource at the time of operation of the digital network according to the definition of the recommended change in use of the resource.

22. A machine-readable medium including instructions executable by the processor comprising
one or more instructions for using a network planning tool prior to a time of operation of the digital network to define a recommended change in use of the resource;
one or more instructions for determining when a resource is needed at the time of operation of the digital network; and
one or more instructions for allocating the resource at the time of operation of the digital network according to the definition of the recommended change in use of the resource.

23. A computer data signal embodied in a carrier wave comprising
a list of recommended routes created at a planning stage of a digital network, to be used by a network control system at a time of operation of the digital network.

24. An apparatus for allocating a resource in a digital network, the apparatus comprising
means for using a network planning tool prior to a time of operation of the digital network to define a recommended change in use of the resource;
means for determining when a resource is needed at the time of operation of the digital network; and
means for allocating the resource at the time of operation of the digital network according to the definition of the recommended change in use of the resource.

25. The apparatus of claim 24, wherein the change in use includes a recommended route.

26. The apparatus of claim 25, wherein a plurality of recommended routes is defined.

27. The apparatus of claim 26, further comprising
means for defining a priority order of the plurality of recommended routes; and
means for allocating the plurality of recommended routes at least in part according to the priority order.
